(19) United States
(12) Patent Application Publication
(10) Pub. No.: US 2002/0101951 A1
(43) Pub. Date: Aug. 1, 2002

(54) Boiling water reactor nuclear power plant

(76) Inventors: Mikihide Nakamaru, Fujisawa-Shi (JP); Hideaki Heki, Yokohama-Shi (JP); Takehiko Saito, Tokyo (JP); Kouji Hiraiwa, Chigasaki-Shi (JP); Tadashi Narabayashi, Yokohama-Shi (JP); Satoru Oomizu, Yokohama-Shi (JP); Tsuyoshi Shimoda, Yokohama-Shi (JP); Kenji Arai, Kawasaki-Shi (JP); Shinichi Morooka, Tokyo (JP); Seijiro Suzuki, Yokohama-Shi (JP)

Correspondence Address: Richard L. Schwaab, FOLEY & LARDNER, Washington Harbour, 3000 K Street, N.W., Suite 500, Washington, DC, 20007-5109, US

(21) Appl. No.: 09/978,304

(22) Filed: Oct. 17, 2001

(30) Foreign Application Priority Data
Oct. 17, 2000 (JP) P.2000-317170

(51) Int. Cl. G21C 9/00

(52) U.S. Cl. 376/282

(57) ABSTRACT

The present invention provides a boiling water-type nuclear power plant comprising: a passive safety system having depressurization valves and a gravity driven core cooling system as an emergency core cooling system; a passive containment vessel cooling system in which reactor steam released in the containment vessel is cooled by a heat exchanger in a cooling water pool installed in the upper portion of the containment vessel; and a containment vessel flooding system which injects cooling water into a dry well of the containment vessel on an accident; wherein a containment vessel spray cooling system for injecting cooling water into the containment vessel via a pump is further added as a safety system. According to the above configuration, it becomes possible to achieve reliable depressurization by an active safety system of the containment vessel on the basis of a simplified passive safety system, and to depressurize the containment vessel and limit radioactive leakage over extended periods after an accident.

### CROSS REFERENCE TO RELATED APPLICATIONS

The present application is based on Japanese Application 317170/2000, filed Oct. 17, 2000, which is herein incorporated by reference in its entirety.

### BACKGROUND OF THE INVENTION

1. Field of the Invention

The present invention relates to a boiling water reactor nuclear power plant, and particularly to a boiling water reactor nuclear power plant with an improved safety system configuration.

2. Description of the Related Art

The emergency core cooling systems and containment vessel cooling systems of boiling water reactor nuclear power plants currently in commercial use are generally designed to have redundancy such that safety is maintained on a pipe break accident leading to or from the core (reactor pressure vessel) even assumed a single failure on these systems, through the combination of network systems for water injection into the core by means of pumps and other active components, and for heat removal from the containment vessel using heat exchangers.

On the other hand, multifaceted studies are already underway on simplified boiling water reactor nuclear power plants with passive safety systems; as a representative example, a configuration which combines a gravity driven core cooling system with depressurization valves to depressurize the nuclear reactor, as an emergency core cooling system, and a configuration adopting a passive containment vessel cooling system in which either steam within the containment vessel is cooled by a heat exchanger within a cooling water pool mounted in the upper portion of the containment vessel, or the cooling water is used to directly cool the outer walls of the containment vessel, as a containment vessel cooling system.

A conventional example of the configuration of the safety system of a boiling water reactor nuclear power plant is explained with reference to FIG. 6 through FIG. 9.

FIG. 6 shows the configuration of the safety system of the recent conventional boiling water reactor nuclear power plant; the emergency core cooling system is configured in three divisions, I, II and III. Division I is configured with the reactor core isolation cooling system 741, low-pressure coolant injection system/residual heat removal system 742, and emergency diesel generator 744; while division II is configured with the high-pressure coolant injection system 743, low-pressure coolant injection system/residual heat removal system 742, and emergency diesel generator 744; and division III is configured with the high-pressure coolant injection system 743, low-pressure coolant injection system/residual heat removal system 742, and an emergency generator 744 for each division. In addition, an automatic depressurization system 745 having a redundancy is provided.

On the other hand, FIG. 7 shows the configuration of the safety system of a simplified boiling water reactor nuclear power plant with passive safety systems. In this configuration there are no safety divisions as in the former case; this configuration adopts, as the emergency core cooling system, depressurization valves 751 which depressurize the reactor core combined with a gravity driven core cooling system 752; as the containment vessel cooling system, a passive containment vessel cooling system 753 which cools steam within the containment vessel using a heat exchanger installed in a cooling water pool above of the containment vessel; and as the reactor core cooling system, a passive reactor core cooling system 754 which uses an emergency condenser. This system is designed such that single failure is assumed only for partially active components such as valves, since single failure of passive component need not to be assumed.

FIG. 8 shows in outline the reactor auxiliary cooling system/auxiliary seawater system of a conventional boiling water reactor nuclear power plant. In the case of this plant, the example of a two-divisions configuration of the reactor auxiliary cooling system/auxiliary seawater system is shown, corresponding to the power supply systems for the two divisions I and II. In this case, if online maintenance of the sea water system is planed, because the seawater intake path has a two-divisions configuration corresponding to the same power supply division, there is the disadvantage that, even if for example spare seawater heat exchangers 761 are installed in each division, online maintenance of the water-intake path 762 itself is not possible, and only maintenance of the seawater heat exchangers can be performed. Nevertheless, if it is necessary to perform online maintenance of the water-intake path, then there is the problem that water-intake path corresponding to each heat exchanger must be provided, so that a total of six water-intake paths become necessary; this is difficult to implement due to cost increases.

In FIG. 9, in the configuration of the passive safety system of a simplified boiling water reactor nuclear power plant, the depressurization valve 771 to depressurize the reactor is connected either directly to the reactor pressure vessel 772, or to the main steam pipe 773.

However, the following problems, exist with respect to the above-described configuration, whether active or passive, of the safety system of the conventional nuclear power plants.

In the former case of an active safety system configuration, if a pipe break is assumed connected to the nuclear reactor and a single failure is assumed in other division component, minimum three divisions of safety system are necessary.

In the latter case of a passive safety system configuration, because the containment vessel pressure is kept comparably high for a long period of accident without declining, there has been the problem, specific to passive containment vessel cooling systems, that the amount of leakage from the containment vessel could not be guaranteed under current rules and standards.

The current problem is to obtain an economical and safety system configuration which resolved both these problems.

One critical path in the periodic inspection period of boiling water-type nuclear power plants is a maintenance of seawater system equipment; it has been known that online maintenance of seawater system equipment is effective in order to reduce this maintenance time. To this end, the current is to obtain a system configuration for seawater system equipment enabling easy online maintenance, and with small cost impact.

The depressurization valve in the passive safety system makes the pressure boundary of the nuclear reactor, and can be opened to the dry well of the containment vessel; hence in order to avoid leakage of steam into the dry well and the loss of coolant accidents (LOCA) due to erroneous opening of the valve, explosive valves using gunpowder, and other special leak-free valves if exist, have been, used. Consequently, periodic valve explosive opening tests and storage of spare valves are obligated, so that handling of the valves has been difficult, and so the current problem is to configure valves so as to guarantee leak free without the use of explosive valves.

### SUMMARY OF THE INVENTION

The present invention had been achieved in order to resolve the above-described problems in the current technology and prior art; an object of the present invention is to achieve reliable depressurization of the containment vessel by an active safety system based on the configuration of a simplified passive safety system.

In order to achieve the above object, the safety system of the nuclear power plant according to the present invention adopts the following configuration.

In the invention of claim 1, there is provided a boiling water reactor nuclear power plant comprising: a passive safety system having depressurization valves and a gravity driven core coolant injection system as an emergency core cooling system; a passive containment vessel cooling system in which steam within the containment vessel is cooled by a heat exchanger in a cooling water pool installed above the containment vessel; and a containment vessel flooding system which drops cooling water into a dry well of the containment vessel during an accident; wherein a containment vessel spray cooling system for injecting cooling water into the containment vessel using pumps is added as a safety system.

According to the present invention, by adding an active containment vessel spray cooling system to the basic configuration of a passive safety system, depressurization of the containment vessel can be performed reliably after an accident, and the amount of radioactivity leakage from the containment vessel can be held to below the allowable value under current standards.

In the invention of claim 2, there is provided a boiling water reactor nuclear power plant according to Claim 1, wherein the containment vessel spray cooling system is composed of two spray cooling systems each having a spray capacity of 100% assumed single failure on an accident thereby to form two divisions, and an emergency power supply system is provided to each of the two divisions in accordance with the two spray cooling systems.

According to the invention specified in claim 2, through the combination of the passive emergency core cooling system and the containment vessel cooling spray system, the division of the safety system can be two in number. This is because a passive gravity driven core cooling system is used as the emergency core cooling system, so that although self-rupture of pipes connected to the core must be assumed, the containment vessel spray cooling system itself is not connected to the core, and so self-rupture need not be assumed, and only single failure need be considered, so that two divisions (100%-capacity×two systems) are sufficient as the active safety system, including the emergency power supply as opposed to the conventional three divisions.

In the invention of claim 3, there is provided the boiling water reactor nuclear power plant wherein the containment vessel spray cooling system comprises two seawater systems for cooling a residual heat removal system and a spare unit of seawater heat exchanger is provided to the respective divisions thereby to form a 50%-capacity×3 units×two systems configuration, while three seawater-intake paths each having a capacity of 100% are provided, and each seawater-intake path is combined with one unit of a seawater heat exchanger in divisions I and II, so that a maintenance on any arbitrary single seawater system can be performed during a normal plant operation.

By means of this invention, a 50%-capacity×3 units×2 divisions configuration is adopted for the seawater system including the reactor auxiliary cooling system heat exchangers with the two-division auxiliary cooling system/seawater system configuration corresponding to the above-described two-division residual heat removal systems, and with the water-intake path of a 100%-capacity ×3 system configuration; by providing with the division I and division II seawater heat exchangers to each water-intake, 100%-capacity of an arbitrary water-intake train can be isolated including the water-intake during normal plant operation, and this configuration enables online maintenance of the seawater systems.

The invention of claim 4 provides a boiling water reactor nuclear power plant wherein the passive safety system with the depressurization valve and the gravity driven core cooling system as an emergency core cooling system further comprises a general pneumatic valve or a motor driven depressurization valve in place of an explosive valve provided on discharge piping of a safety relief valve in dry well of the pressure containment vessel, so that leakage of reactor steam into the dry well during normal plant operation can be substantially prevented.

The above invention provides the configuration of the depressurization valve of the passive safety system; by installing on the safety relief discharge piping which acts in the same operating mode of an automatic depressurization system, open on the dry-well side, a general pneumatic (air-operated) valve or a motor-driven valve is possible instead of the conventional explosive valve is possible. Because the discharge line of the safety relief valve is submerged in the water of the pressure-suppressing pool, so that even if the safety relief valve were to leak, there is little possibility of the depressurization valves simultaneously leak, and so the steam would be condensed within the pressure-suppressing pool, and there would be no leakage on the dry-well side.

### BRIEF DESCRIPTION OF THE DRAWINGS

FIG. 1 is a system diagram showing the entirety of the boiling water reactor nuclear power plant according to one embodiment of the present invention.

FIG. 2 is a schematic diagram showing a relation between the safety system and power sources of the plant of the above embodiment.

FIG. 3 is a schematic diagram showing the safety system of the plant of the above embodiment.

FIG. 4 is a schematic diagram showing the auxiliary cooling/auxiliary seawater systems of the plant of the above embodiment.

FIG. 5 is a schematic diagram showing the depressurization valves of the boiling water reactor nuclear power plant of the above embodiment FIG. 6 is a schematic diagram of an example of the prior art, showing the safety system of the recent boiling water reactor nuclear power plant FIG. 7 is a schematic diagram of an example of the prior art, showing the safety system of a simplified boiling water reactor nuclear power plant FIG. 8 is a schematic diagram of an example of the prior art, showing the auxiliary cooling/auxiliary seawater systems of a conventional boiling water reactor nuclear power plant

FIG. 9 is a schematic diagram of an example of the prior art, showing the depressurization valves of a simplified boiling water reactor nuclear power plant

### DESCRIPTION OF THE PREFERRED EMBODIMENTS

Hereinafter, embodiments of the boiling water reactor nuclear power plant of the present invention is explained with reference to the attached drawings. These embodiments are applied to, for example, a 100 MWe-class boiling water reactor nuclear power plant.

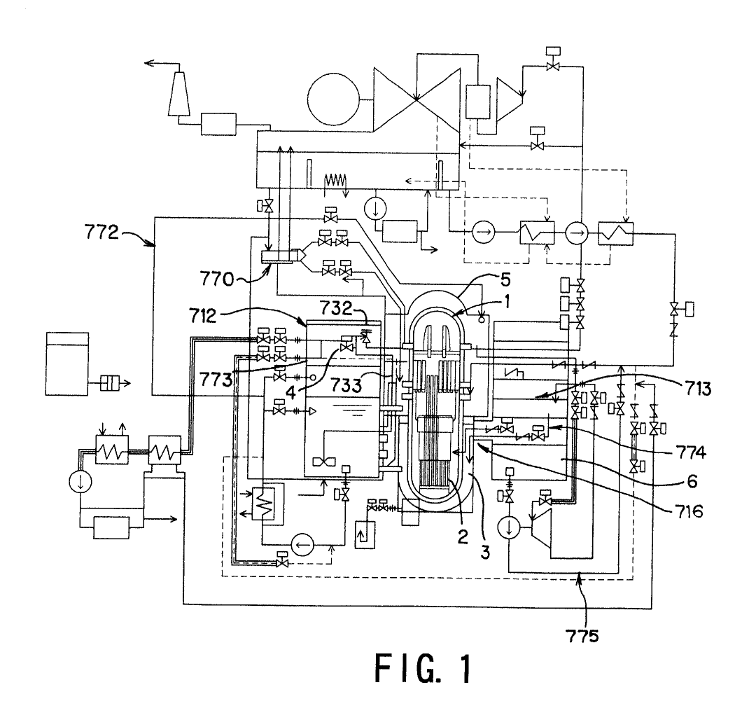

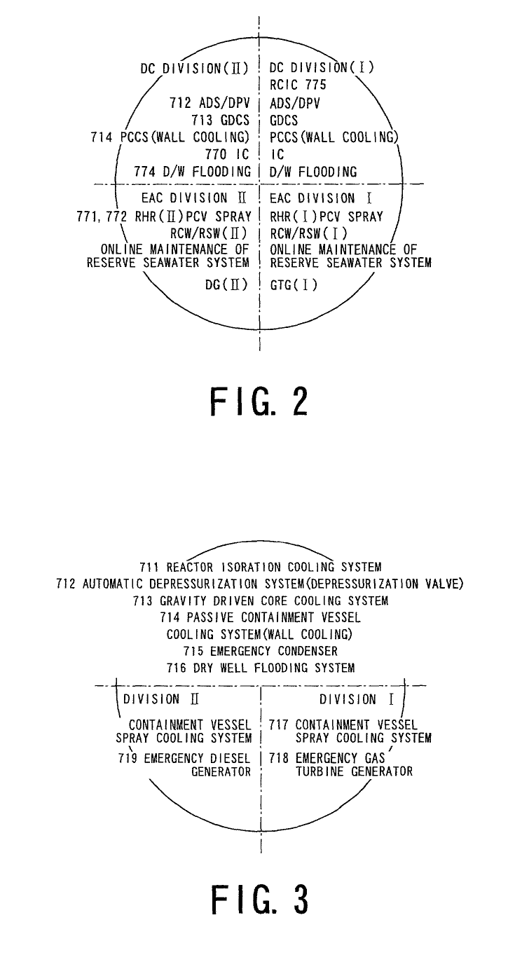

FIG. 1 is a system diagram showing the overall configuration of the boiling water reactor nuclear power plant of this embodiment; FIG. 2 is a schematic diagram of the safety system.

As shown in FIG. 1, this plant is a natural-circulation boiling water reactor nuclear power plant having the reactor core 2 at the bottom portion of the reactor pressure vessel 1, and having an internal upper-entry control rod driving mechanism, above the reactor core 2. As the safety system for the reactor core 2 and dry well 3, there are provided a gravity driven core cooling system 713 and a passive containment vessel cooling system 714. In addition, an automatic depressurization system 712, emergency condenser 770, residual heat removal system 771 are provided.

As shown in FIG. 2, DC power supply (DC) divisions (I) and (II) are usually provided. These power supply divisions comprise a gravity driven core cooling system (GDCS) 713, passive containment vessel cooling system (PCCS) 714 and automatic depressurization system (ADS) 712, depressurization valve (DPV) 712, emergency condenser (isolation condenser, IC) 770, dry well flooding system (DFS), reactor core isolation cooling system (RCIC) 775, and similar.

Emergency AC power supply (EAC) divisions I and II are provided, and each of these power supply divisions comprises a reactor residual heat removal system (RHR) 771, pressure containment vessel spray (PCV spray) system 772, reactor auxiliary cooling system (RCW/RSW), seawater system heat exchanger valve and similar, emergency diesel generator (DG), gas turbine generator (GTG), and similar. The emergency AC power source division (I) adopts a diesel generator (DG), while the emergency AC power source division (II) adopts a gas turbine generator (GTG).

FIG. 3 is a schematic example showing the safety system of the plant shown in FIG. 1.

In the safety system of this embodiment, a division which operates under an emergency DC power supply system not depending on an emergency AC power supply comprises a reactor isolation core cooling system 711; automatic depressurization system (depressurization valve) 712; gravity driven core cooling system 713; passive containment vessel cooling system (wall cooling, or passive containment vessel cooling heat exchanger) 714; dry well flooding system 716, and similar.

Further, division 1, which depends on an emergency AC power supply, comprises a containment vessel spray cooling system 717 and emergency gas turbine generator 718 and similar. In contrast, division II, which depends on an emergency AC power supply, comprises a containment vessel spray cooling system and an emergency diesel generator 719 and similar.

This embodiment, configured as described, has the following actions and functions.

In cases a loss of coolant accident occurs, when the reactor water level drops, the reactor is depressurized, and in order to promote injection by the gravity driven core cooling system 713, the depressurization valve 4 opening into the dry well 2 is opened; by allowing the reactor steam to release into the dry well 3, so that the differential pressure between the reactor pressure vessel 1 and the reactor containment vessel 5 is equalized to the injection pressure of the gravity driven cooling system 713.

When the gravity driven cooling system 713 begins injection, the water level of the reactor pressure vessel 1, which has lowered due to the reactor stem blowdown, again rises. As a result, the reactor water level is maintained above the top of the fuel. Therefore, the core is not exposed; and thereafter also, condensed water from the released reactor into the reactor containment vessel 5 is circulated as gravity driven cooling system water, so that a sufficient core cooling can be continued.

Further, the reactor steam and the water released into the pressure containment vessel 5 causes a rise of the temperature and pressure in the pressure containment vessel 5. However, through the PCV wall cooling of the passive containment vessel cooling system (PCCS) (or, through the passive containment vessel cooling heat exchanger), sufficient cooling is maintained below the design pressure and temperature. Thereafter, the containment vessel spray cooling system 772, which is active component, is initiated, and cools until the containment vessel pressure and temperature are lowered to a low-pressure and cold condition, so that radioactive material released into the containment vessel is not released into the environment in amounts exceeding the allowable value.

On the other hand, even if a severe accident scenario should be assumed, in which double failures are assumed and the active safety system does not operate, there is a passive containment vessel cooling system based on containment vessel wall cooling or on a passive containment vessel cooling heat exchanger, so that the containment vessel pressure and temperature are maintained below design values.

In case of a severe accident, the dry well flooding system operates separately from the above system and pressure-suppression pool water can be dropped into the lower part of the dry well, so that even if the core fuel within the reactor pressure vessel 1 is melted down to the bottom of the reactor pressure vessel 1, the reactor pressure vessel 1 would be submerged in water, and the molten fuel could be cooled from the exterior of the reactor pressure vessel, so that the molten fuel would not penetrate the reactor pressure vessel 1 and would not drop to the bottom of the dry well 3.

It is anticipated that a loss of coolant accident occurs in the case of rupture of pipes connected to the reactor pressure vessel 1. Pipes connected to the reactor pressure vessel 1 of this invention include the main steam system, feed water system, gravity driven core cooling system, emergency condenser (supplying steam, returning condensed water), and shutdown cooling system (suction).

In these systems, the only system related to the number of required emergency divisions is the gravity driven core cooling system. However, even if a self-rupture of these pipes is considered, since it is sufficient to provide redundancy in the operating valves in order to satisfy for single failure rule, a 100%-capacity×two-divisions configuration (or, a 50%-capacity×two units×two-divisions) configuration is sufficient. That is, according to this embodiment, because a gravity driven cooling system is adopted as the core injection system without an active injection system, it is sufficient to have two divisions for the systems needed for an emergency AC power supply. Hence the number of emergency divisions depending on an emergency AC power supply can be simplified and streamlined to two divisions from the three divisions of conventional plants.

In cases of loss of feed water or rupture of small-diameter pipes connected to the reactor pressure vessel and similar, when the reactor water level is lowered below a predetermined value, the reactor isolation cooling system is initiated, and water in the pressure suppression pool 6 is supplied to the reactor, thereby to cause the reactor water level to recover. This system has been implemented in the past through a combination with the safety system of active component; however, there had been no example of combination with the safety system using passive component, as like in this embodiment.

In a passive safety system configuration as in this embodiment, there have been example ideas to use a conventional control rod driving hydraulic system as an enforced make up system during the reactor high pressure condition. However, there are problems to some extent with capacity or method of operation and other aspects, whereas by using this reactor isolation cooling system, the same capacity and reliability as those of the conventional plant can be secured.

In cases a safely shutdown of the nuclear reactor is necessary, due to reactor transient event, the reactor can be shut down with the reactor pressure vessel 1 in an isolated high temperature condition by means of the emergency condenser 770. Consequently, there is no need, as in the conventional plant, to cool the reactor to a cold shutdown condition with the residual heat removal system operation, as the safety system which is active component, after depressurization of the reactor using safety, relief valves with maintaining the reactor water level by the reactor isolation cooling system.

Because of the above configuration, there is no need to perform open/close tests of suction and return isolation valves which are connected in the shutdown cooling mode as part of the residual heat removal system during normal reactor operation, and so it is possible to eliminate possibility over an interface LOCA (loss of coolant accident: accidents in which, during valve open/close tests, another valve breaks, high-pressure reactor water flows into pipes of a residual heat removal system designed for low pressures, causing rupture of system pipes, so that coolant loss occurs outside the containment vessel) due to the lower design pressure of the residual heat removal system than that of the reactor side.

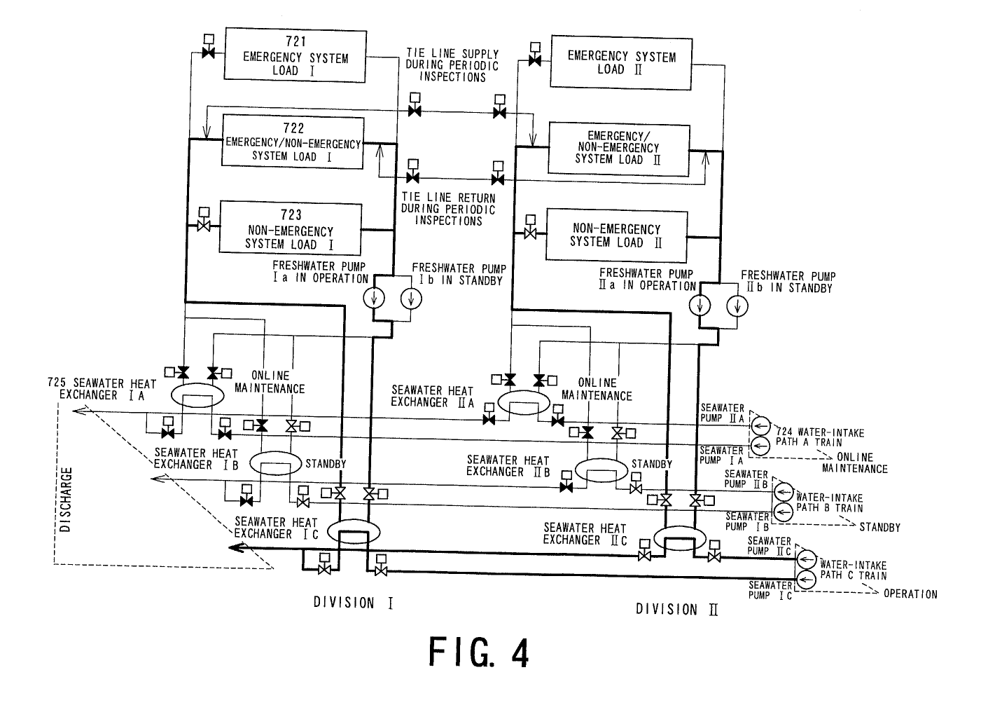

Similarly, in the embodiment shown in FIG. 4, division I and II corresponding to power supply divisions comprise the auxiliary cooling system and seawater system. In each division, the emergency load 721, emergency/non-emergency load 722 and non-emergency load 723 are grouped.

Further, there are two seawater systems. The seawater-intake path 724 of the seawater system comprises, separately from the two divisions, three trains A, B and C. The valves of the seawater heat exchangers 725 and seawater pumps 726 are configured into division I and division II, corresponding to each power supply division; but the location of installation of the heat exchangers and pumps themselves are such that seawater heat exchangers and seawater pumps IA and IIA, seawater heat exchangers and pumps IB and IIB, and a seawater heat exchanger and pumps IC and IIC, are installed in the same train section, corresponding to the seawater system water-intake path trains A, B and C.

Each of the heat exchangers and pumps has half capacity required for one seawater system, so that the arrangement of two seawater system, which include three heat exchangers each having half capacity required for one seawater system a division totally, provides three times of one seawater system capacity.

FIG. 4 shows the condition of online maintenance of the train A heat exchanger, seawater pumps and water-intake path during regular plant operation.

Train A is isolated for maintenance, train B is placed on standby condition, and train C is operated to cool the loads of the reactor auxiliary components in divisions I and II during regular plant operation. This online maintenance of train is rotated, in a configuration enabling maintenance of any of the trains A, B or C.

Once an accident occur, the train B on standby is automatically started, so that cooling water can be supplied to divisions I and II of the emergency load. At this time, even if a single failure were assumed in the power supply of division 1, where the seawater pumps connected to the power supply of division II for trains B and C are started, so that cooling water could be supplied at full capacity of 100% to the seawater heat exchanger of division II, and full-capacity of cooling for the emergency load of division II can be performed.

Online maintenance of this seawater system is possible for all trains during normal plant operation. Therefore, for example, if all three trains are operated during normal reactor shutdown cooling, the temperature of the cooling water supplied to the residual heat removal (RHR) system can be further lowered, so that the specifications for the heat removal condition of the heat exchangers of this residual heat removal system can be relaxed.

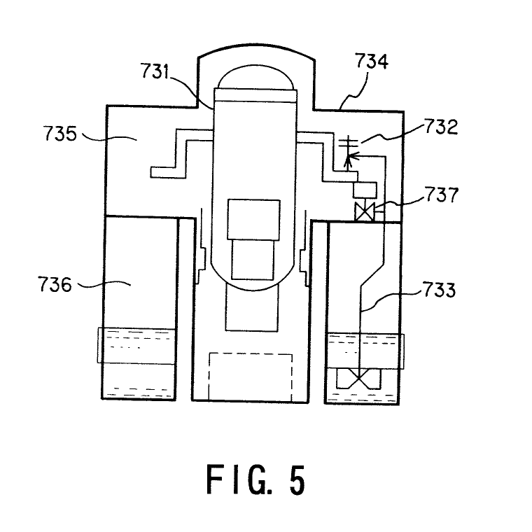

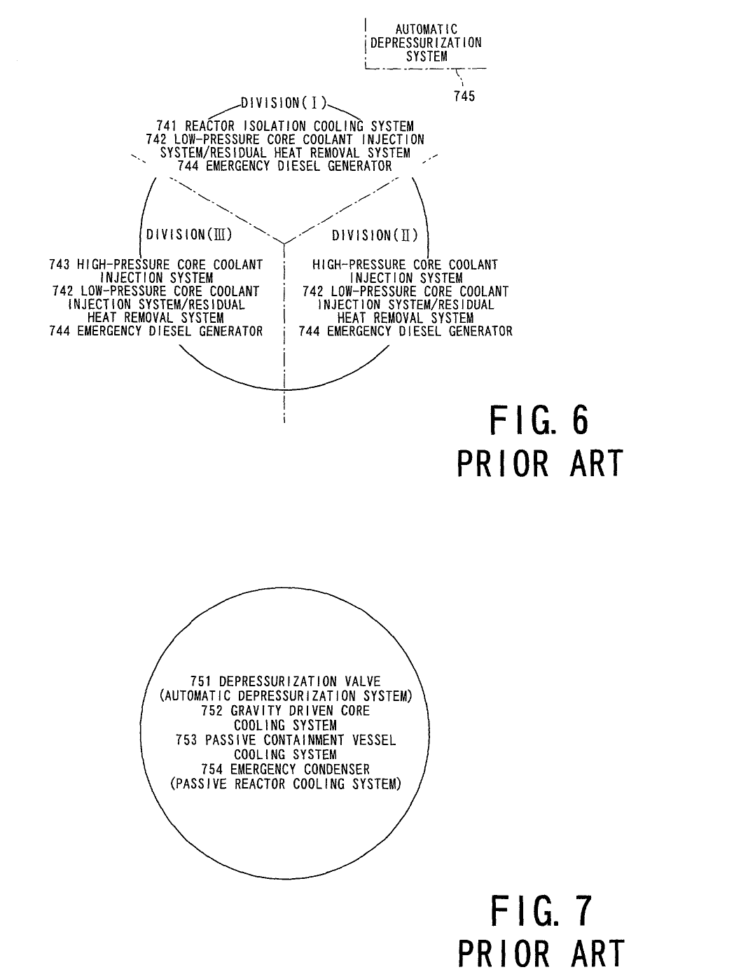

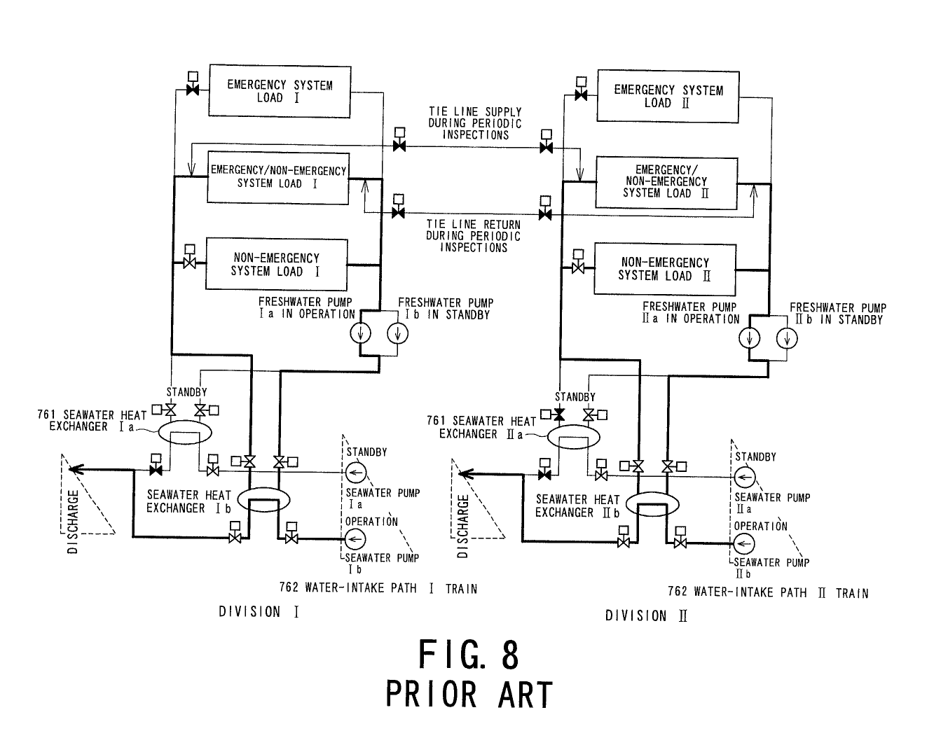

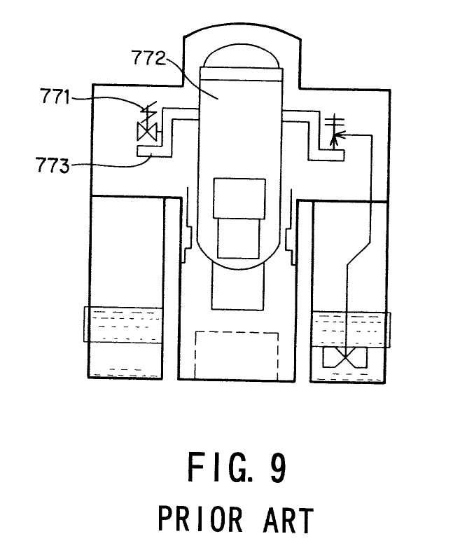

FIG. 5 shows another embodiment of the present invention.

In this embodiment, as opposed to a general passive safety system configuration, the depressurization valve 737 for depressurizing the reactor is installed on the safety relief valve discharge piping 733 connected to the safety relief valve 732 of the reactor pressure vessel 731, such that the reactor steam is released into the dry well 735 of the pressure containment vessel 734 during depressurization of the reactor.

In cases in which a loss of coolant accident occurs and the reactor water level falls, the reactor is depressurized, and in order to promote the gravity driven core cooling system injection, first the safety relief valve 732 is opened in the automatic depressurization system, the reactor steam is discharged into the pressure-suppression pool 736.

The reactor pressure is depressurized to an extent of a pressure corresponding to water submergence head in the pressure suppression pool 736, and this pressure, in addition to the pressure loss of the safety relief valve discharge piping 733. Thereafter, the depressurization valve 737 opening into the dry well 735 is opened and the reactor steam is further discharged into the dry well 735, by which means the differential pressure between the reactor pressure vessel 731 and the pressure containment vessel 734 is equalized to the injection pressure of the gravity driven cooling system.

Further, during normal plant operation, even if a leakage of the safety relief valve 732 occurs, the steam passes through the safety relief valve discharge piping and is condensed in the pressure suppression pool, so that there is no increase in the pressure in the safety relief valve discharge piping 733, and there is no direct leakage of steam from the depressurization valve 737 to the dry well side.

Therefore, the problems with a passive safety system are resolved, and a reliable depressurization of the containment vessel by an active safety system can be achieved.

As explained above, according to the present invention, an economical safety system configuration can be achieved in which the problems of passive safety systems are resolved, and moreover a reliable depressurization of the containment vessel can be obtained by an active safety system. In addition, online maintenance of seawater systems can be realized.

What is claimed is:

1. A boiling water reactor nuclear power plant comprising:
a passive safety system having a depressurization valve and a gravity driven core cooling system as an emergency core cooling system;
a passive containment vessel cooling system in which a reactor steam released into a containment vessel is cooled by a heat exchanger in a cooling water pool installed in the upper portion of the containment vessel;
a containment vessel flooding system which injects cooling water into a dry well of the containment vessel on an accident; and
a division having a spray cooling system as a safety system which injects cooling water into the containment vessel via a pump.

2. The boiling water reactor nuclear power plant according to claim 1, wherein each of the two divisions has a spray system having a full capacity for the boiling water reactor nuclear power plant.

3. The boiling water reactor nuclear power plant according to claim 1, further comprising a residual heat removal system which removes residual heat of the containment vessel, a seawater system having a plurality of seawater heat exchangers and a plurality of seawater-intakes for cooling the residual heat removal system, wherein a first seawater system and a second seawater system have a first, a second and a third heat exchangers, each heat exchanger has half capacity for one seawater system, a first seawater-intake is connected to the first heat exchanger in the first seawater system and the second seawater system, and a second seawater-intake is connected to the second heat exchanger in the first seawater system and the second seawater system, and a third seawater-intake is connected to the third heat exchanger in the first seawater system and the second seawater system, each seawater-intake has full capacity for one seawater system.

4. The boiling water reactor nuclear power plant according to claim 1, wherein said passive safety system having the depressurization valve and the gravity driven core cooling system as an emergency core cooling system further comprises a general pneumatic valve or a motor-driven depressurization valve in place of an explosive valve or a leak-free valve, and the pneumatic valve or motor-driven depressurization valve is mounted on a discharge piping of a safety relief valve disposed in the dry well of the containment vessel.
